(19) United States
(12) Patent Application Publication
(10) Pub. No.: US 2014/0257657 A1
(43) Pub. Date: Sep. 11, 2014

(54) METHOD AND SYSTEM FOR CONTROLLING A POWER TRAIN DEPENDING ON THE TEMPERATURE OF A HYDRAULIC TORQUE CONVERTER

(71) Applicant: RENAULT s.a.s., Boulogne-Billancourt (FR)

(72) Inventor: Francois Plante, Champcueil (FR)

(73) Assignee: RENAULT s.a.s., Boulogne-Billancourt (FR)

(21) Appl. No.: 14/349,544

(22) PCT Filed: Sep. 18, 2012
(86) PCT No.: PCT/FR2012/052082

§ 371 Date: Apr. 29, 2014

(30) Foreign Application Priority Data
Oct. 6, 2011 (FR) 1159032

(51) Int. Cl. F16D 33/00

(52) U.S. Cl. CPC F16D 33/00
USPC 701/68

(57) ABSTRACT

A system for controlling a power train of a motor vehicle, the power train configured to deliver an engine torque to a hydraulic torque converter. The control system includes a mechanism determining a temperature gradient of oil of the hydraulic torque converter, a mechanism estimating a curve of force of resistance to forward travel of the motor vehicle depending on a practical mass of the motor vehicle based on the temperature gradient, and a controller controlling the engine torque depending on the estimation.

The invention relates to the control of a power train, and more particularly to a control of a coupled power train depending on the temperature of the oil of a hydraulic torque converter.

A torque converter corresponds to a type of hydraulic coupling used to transmit power from a drive shaft to a rotating driven load. The hydraulic torque converter generally replaces a mechanical clutch by allowing the load to be isolated from the power source, that is to say, in the case of a motor vehicle, mechanically decoupling from the engine the drive chain comprising the shaft coupled to a wheel. A hydraulic torque converter also makes it possible to implement a gear reduction, that is to say to increase the torque when the input and output speeds of rotation are different, thus becoming the equivalent of a mechanical reducer.

A hydraulic torque converter comprises a pump, a stator and a turbine mounted in a common casing, in which the oil ensures the transmission of the torque and circulates there in a closed circuit.

The off-road usage of a motor vehicle, in particular when ascending steep inclines or when progressing through sand or a deep slough for example, may result in conditions very close to takeoff conditions, lasting for a long period. In other words, the motor vehicle, for a relatively long period, may have a speed close to zero or a generally low speed, whereas the engine develops a significant torque.

Under these conditions, for the case of motor vehicles equipped with hydraulic torque converter automatic transmissions, the necessary energy to be transmitted to the drive chain must be maximal in order to be able to simply leave the location where the vehicle is located. In accordance with the very principle of operation of a hydraulic torque converter, the maximum torque transmitted can only be obtained in the case in which this converter is at a maximum decoupling level, which, if the engine is then used at the maximum performance thereof, leads to a maximum shearing of the oil located there. This is translated into a loss of power transmission from the engine to the drive chain due to reheating of the oil in the hydraulic torque converter. In fact, at any moment at which the engine speed is greater than the speed of the turbine, the balance of powers shows explicitly that the shearing of the oil is translated into a dissipation of power equal to the difference between the power produced by the engine, corresponding to the product of the engine torque and of the crankshaft speed, and the power transmitted by the converter to the turbine, corresponding to the product of the output torque of the converter and of the turbine speed.

In addition, the overheating of the oil beyond specific temperature thresholds causes structural elements of the automatic transmission to break. The level of thermal stress of a hydraulic torque converter thus limits the possibility of crossing zones that put up a high resistance to forward travel, such as zones having a steep incline, for example.

The problem of overheating of the oil is linked to the impossibility of forecasting the traveling conditions of the motor vehicle. The traveling conditions of a motor vehicle are linked in part to the mass of the vehicle and to the force of resistance to forward travel of the motor vehicle, the force of resistance to forward travel possibly corresponding to the incline that the motor vehicle is in the process of ascending and/or to the nature of the terrain in which the motor vehicle is moving.

The existing solutions tend to eliminate this thermal stress and ensure a reliability and a durability of the structural elements of the transmission, but do so however to the detriment of the clearing ability of the vehicle, that is to say the ability to ascend inclines or to cross deep zones.

The majority of motor vehicles able to ascend steep inclines are equipped with gear reducers, which shorten the gear ratios, thus making it possible to cross the zones putting up a significant force of resistance to forward travel, almost without ever, or quasi marginally, reaching the authorized limits for thermal stress of the oil. The load returned at the converter is at this point reduced, such that the vehicle quickly accelerates.

The turbine of the hydraulic converter is mechanically connected to the drive wheels of the vehicle by means of a transmission with a given gear ratio. In the case in which the “short-range” gear ratios are used, the shearing of the oil in the converter thus reduces. Generally, the maximum shearing point obtained in this configuration is thus pushed back toward ratio values between the practical mass of the vehicle and the incline well beyond any reasonable use.

The problem is that, due to financial cost reasons, a motor vehicle is not always equipped with a device for reducing the gear reduction of the automatic gear ratios, and the most gear-reducing ratio is less gear reducing than that known generally with a conventional mechanical gearbox, due to the construction itself of this type of transmission. As a result, in order to scale the force of resistance to forward travel, that is to say in order to scale inclines or the nature of terrains, maximum thermal stress conditions often prevail, that is to say conditions of maximum shearing of the oil in the hydraulic torque converter often prevail, thus causing an overheating of the oil.

A known solution proposes measuring the temperature of the oil of the hydraulic torque converter, then, when the risk of overheating is considered significant, short-circuiting the hydraulic torque converter by tightening a friction clutch in parallel with the converter, and/or severely lowering the flow of energy in the oil as a result of the collapse of the engine torque.

However, in this case, the torque transmitted to the drive chain becomes severely insufficient. In the case of an incline to be ascended for example, the force of gravity, which is constant, thus prevails over the traveling force, and the balance of the forces to which the motor vehicle is subjected is lost. The vehicle thus suddenly moves back, without any prior indication to the driver of the imminence of this event, moreover in a direction which is not often the natural direction in relation to the orientation of the driving position.

In the case of a terrain such as sand or a slough, the vehicle stops suddenly.

Document US 2011/0054749 proposes controlling the engine torque so as to limit the thermal stress rate of the oil by controlling this engine torque on the basis of the measured value of the oil temperature of the hydraulic transmission such that an oil temperature value deemed critical is never exceeded.

However, the action on the engine torque is a process of the proportional integral derivative (PID) type, performed directly on the basis of information concerning the oil temperature so as to satisfy a criterion with respect to a critical value. Such a control with respect to the oil temperature does not make it possible to anticipate the behavior of the vehicle at any moment. Since the behavior of the motor vehicle cannot be predicted, the adjustment of the critical temperature forbids temporary fluctuations of the oil temperature toward oil temperatures greater than the critical temperature, thus making it possible to provide an additional clearing force over a short period of time, without putting at risk the structural elements of the hydraulic torque converter or of the hydraulic control system of the transmission.

In addition, the application is limited only to the “stall point” case, thus implying the use of information concerning the main brake.

One object of the invention is to overcome these disadvantages and therefore to implement, at any moment, the best possible compromise between the thermal resistance of the hydraulic torque converter or of the hydraulic control system of the transmission in question and the maximum force exerted against the force of resistance to forward travel. This thus concerns the preservation of a maximum clearing force exerted against the force of resistance to forward travel, whatever the mass of the vehicle, and the preservation of said maximum clearing force at any moment, avoiding this thermal stress. This is achieved moreover without the use of additional sensors or means making it possible to provide information concerning the load conditions of the motor vehicle imposed by the terrain.

A further object of the invention is to benefit from a clearing force reserve making it possible to clear an obstacle, such as humps or holes, when the vehicle is already in a zone putting up a high resistance to forward travel, such as an incline or a sandy terrain, moreover without risking degradation of the structural elements of the hydraulic torque converter or of the hydraulic control system of the transmission.

In accordance with one aspect of the invention, a method for controlling a power train of a motor vehicle is proposed in one implementation, the power train being capable of delivering an engine torque to a hydraulic torque converter.

In accordance with a general feature, the method comprises the determination of a temperature gradient of the oil of the hydraulic torque converter, the estimation of a curve of the force of resistance to forward travel of the motor vehicle depending on a practical mass of the motor vehicle based on said temperature gradient, and a control of said engine torque depending on said estimation.

Such a method thus makes it possible to estimate a relative torque linking a force of resistance to forward travel and a practical mass of the motor vehicle, without the use of additional sensors or actuators. The practical mass of the vehicle corresponds to the sum of the mass of the motor vehicle with the mass of the people and goods and/or of a towed trailer.

The continuous management in real time of the adaptation of the engine torque to the surrounding circumstances, that is to say to the force of resistance to forward travel of the vehicle, makes it possible to anticipate the behavior of the motor vehicle and consequently to give the driver maximum confidence in the behavior of his motor vehicle, which remains constant and foreseeable. By controlling the engine torque transmitted to the hydraulic torque converter with respect to the estimated curve of the force of resistance to forward travel depending on the practical mass, it is possible to anticipate critical situations and to avoid an interruption of torque to the wheels associated with such a situation. The circumstantial corrections of the torque applied to the wheels are never severe and do not lead the driver and his vehicle, without warning, into dangerous situations, which could clearly put them instantly in danger, as well as passengers or third parties.

The temperature gradient is advantageously determined based on the difference between two measurements of the temperature of the oil separated by a critical period.

The determination of the temperature gradient makes it possible to deduce the period of time over which the vehicle can function with a significant engine speed and engine torque before reaching an overheating temperature of the oil, and thus makes it possible to anticipate the behavior of the motor vehicle. The determination of the temperature gradient thus makes it possible to know the period of time over which the maximum engine torque making it possible to obtain a maximum clearing force is available for a curve of the force of resistance to forward travel depending on the given practical mass.

The control of the engine torque preferably limits the engine torque when the estimated curve of the force of resistance to forward travel depending on a practical mass is between a static thermal iso-stress curve and a maximum thermal iso-stress curve.

The static thermal iso-stress curve may advantageously correspond to the maximum force of resistance to forward travel depending on the practical mass for which the temperature of the oil remains below an overheating temperature, whatever the value of the engine torque and the period of time over which it has built up.

The overheating temperature of the oil corresponds to the temperature of the oil from which there is a risk of degradation of the elements of the hydraulic torque converter if such a temperature or a greater temperature is maintained even over a relatively short time.

The maximum thermal iso-stress curve may advantageously correspond to the force of resistance to forward travel depending on the practical mass of the stall point of the torque converter.

When the estimated curve of the force of resistance to forward travel depending on a practical mass is below the static thermal iso-stress curve, the hydraulic torque converter is experiencing operating conditions with no risk of overheating of the oil. The engine torque therefore does not need to be limited in order to reduce the temperature of the oil.

The maximum thermal iso-stress curve corresponding to the stall point is, for given characteristics of the engine, of the hydraulic converter, of the transmission and of the mass of the vehicle, and for maximum ambient temperature conditions of the vehicle or maximum engine compartment temperature conditions, a practical absolute limit in the sense that it never reaches a situation in which the thermal stress is greater than the case in point.

If the force of resistance to forward travel is very strong, in spite of the engaged gear ratio, the speed of the turbine of the torque converter is almost zero, whereas the engine speed, enforced at the turbine pump, is relatively high. The “stall” point of the torque converter corresponds to an equilibrium value of the forces in action, in the present case the force of the engine torque and the force of resistance to forward travel. The stall point of the torque converter is reached when, at a given practical mass, the force of resistance to forward travel is equal to the maximum available force produced by the engine torque in the case of maximum shearing of the converter, and is geared down by the hydraulic converter and the automatic transmission as far as the wheels.

The control of the engine torque is advantageously activated when the temperature of the oil is greater than an activation temperature.

The activation temperature preferably corresponds to the maximum temperature observed for normal traveling conditions of the vehicle.

Since the control is only useful when the temperature of the oil approaches an overheating temperature, the control can only be activated from an oil temperature value greater than an oil temperature representative of normal traveling conditions, that is to say traveling conditions on a tarmacked road.

The critical period preferably corresponds to the time taken for the oil to pass from the activation temperature to said overheating temperature when the temperature gradient corresponds to the temperature gradient of the stall point.

In accordance with another aspect of the invention, a system for controlling a power train of a motor vehicle is proposed in one embodiment, the power train being capable of delivering an engine torque to a torque converter.

In accordance with a general feature, the system comprises means for determining a temperature gradient of the oil of the hydraulic torque converter, means for estimating a curve of the force of resistance to forward travel of the motor vehicle depending on a practical mass of the motor vehicle based on said temperature gradient, and means for controlling said engine torque depending on said estimation.

The system preferably comprises a temperature sensor capable of measuring the temperature of the oil in the hydraulic converter and coupled to the determination module, the determination module determining the temperature gradient based on the difference between two measurements of the temperature of the oil separated by the critical period.

The control means may advantageously comprise a module for limiting the engine torque capable of determining a limited engine torque when the estimated curve of the force of resistance to forward travel depending on a practical mass is between a static thermal iso-stress curve and a maximum thermal iso-stress curve, the static thermal iso-stress curve corresponding to the maximum force of resistance to forward travel depending on the practical mass for which the temperature of the oil remains below an overheating temperature, whatever the value of the engine torque and the period of time over which it has built up, and the maximum thermal iso-stress curve may advantageously correspond to the force of resistance to forward travel depending on the practical mass of the stall point of the torque converter.

The system may also comprise an activation module coupled to the temperature sensor and capable of activating the control system when the temperature of the oil is greater than an activation temperature, the activation temperature corresponding to the maximum temperature observed for normal traveling conditions of the vehicle.

The activation module may also be capable of deactivating the control system when the temperature of the oil is below a deactivation temperature, the deactivation temperature corresponding to a temperature indicative of a return to normal traveling conditions of the vehicle.

Further advantages and features of the invention will become clear upon examination of the detailed description of implementations and embodiments, which are in no way limiting, and of the accompanying drawings, in which:

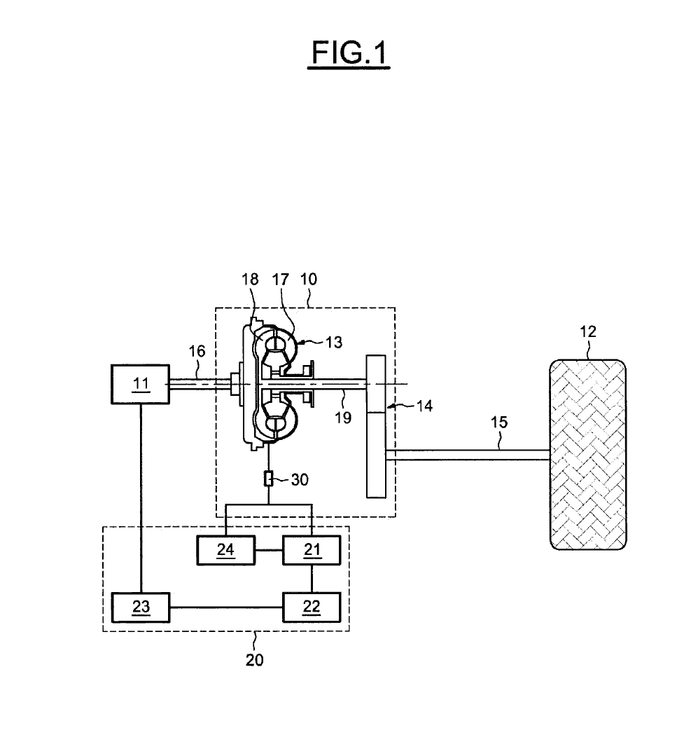

FIG. 1 schematically shows a motor vehicle portion comprising an exemplary system for controlling a power train in accordance with one embodiment of the invention;

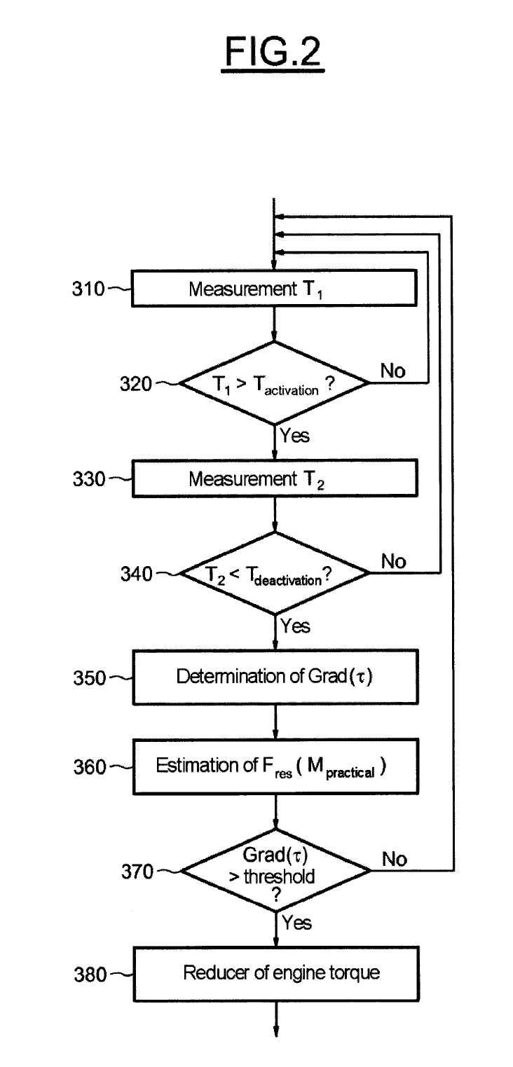

FIG. 2 shows a flow chart of an exemplary method for controlling a power train in accordance with one implementation of the invention;

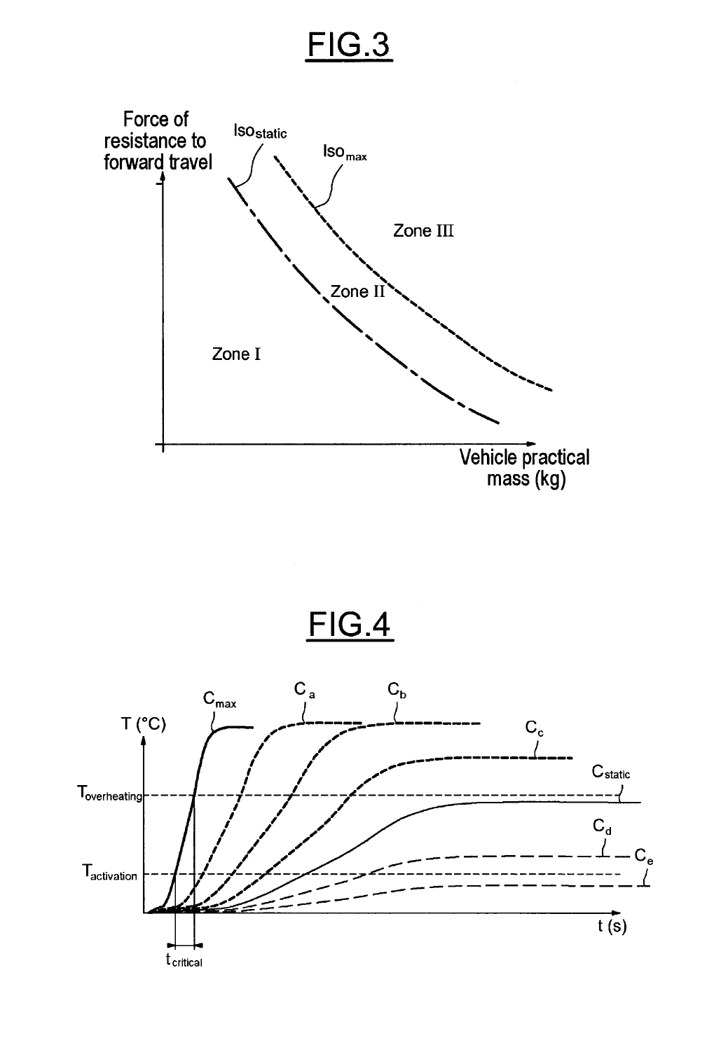

FIG. 3 illustrates thermal iso-stress curves for a force of resistance to forward travel depending on a practical mass of a motor vehicle;

FIG. 4 illustrates curves of variation of the temperature of the oil as a function of time.

A portion of a motor vehicle comprising an exemplary system for controlling a power train in accordance with one embodiment of the invention is illustrated schematically in FIG. 1.

The motor vehicle comprises an automatic transmission unit 10 coupled between an engine 11 and at least one wheel 12. The transmission unit 10 comprises a hydraulic torque converter 13 and an automatic transmission or gearbox 14. The hydraulic torque converter 13 is inserted between the engine 11 and the gearbox 14, which is mechanically connected to the wheel 12 via a shaft 15 of the drive chain.

The torque converter 13, from the engine torque transmitted via a crankshaft 16 from the engine 11 to a pump 17 of the torque converter 13, generates a transmission torque delivered by a turbine 18 of the torque converter 13 to the gearbox 14 via a primary shaft 19. The transmission torque is generated by the oil in the hydraulic torque converter 13 moved by the rotation of the pump 17.

The motor vehicle comprises a system 20 for controlling the engine 11, capable of controlling the engine torque delivered by the engine 11 depending on the temperature of the oil of the hydraulic torque converter 13 of the automatic transmission unit 10 of the motor vehicle. The control system 20 comprises means 21 for determining a temperature gradient of the oil, capable of determining a temperature gradient based on measurements of the temperature of the oil performed by a temperature sensor 30, means 22 for estimating a curve of the force of resistance to forward travel of the motor vehicle depending on a practical mass of the motor vehicle based on said temperature gradient, and means 23 for controlling the engine torque depending on the estimation, capable of controlling the engine 11. The control system 20 also comprises an activation module 24 coupled to the temperature sensor 30 and to the determination means 21 and capable of activating the control system via the determination means 21 when the temperature of the oil is greater than an activation threshold T_{activation}.

In one implementation, the control system 20 operates in accordance with the exemplary method for controlling the hydraulic torque converter 13 presented in the flow chart of FIG. 3.

In a first step 310, the temperature sensor 30 measures a first temperature T₁ of the oil in the hydraulic torque converter 13.

During the operation of the motor vehicle, the torque converter 13 ensures the generation of a transmission torque to the gearbox 14 via the primary shaft 19 coupled to the turbine 18 of the torque converter 13 from an engine torque generated by the engine 11 and transmitted to the pump 17 of the torque converter 13 via the crankshaft 16. The transmission torque is generated by the movement, and more particularly the rotation, of the oil by the pump 17 of the torque converter 13. The torque difference between the engine torque at the pump 17 and the transmission torque at the turbine 18 causes a shearing of the oil and consequently a dissipation of energy by means of heating of the oil.

During the normal operation of the motor vehicle, that is to say during operation on a tarmacked road, with average traveling conditions, the temperature of the oil has an average traveling value. This average traveling value, or a relatively higher value, corresponds to the activation threshold temperature T_{activation} of the control system 20 by the activation means 24.

Thus, after the measurement of the first temperature T₁, the first temperature T₁ of the oil is compared in a following step 320 with the activation threshold T_{activation}. If the first temperature T₁ is below the activation threshold T_{activation}, the control system 20 remains inactivated.

By contrast, if the first temperature T₁ is above the activation threshold T_{activation}, the control system is activated.

In a following step 330, the temperature sensor 30 measures a second temperature T₂ of the oil. The second temperature T₂ is measured after a critical period t_{critical}, which has elapsed since the measurement of the first temperature T₁.

The critical period t_{critical} corresponds to the time taken for the oil to pass from the temperature corresponding to the activation threshold T_{activation} to an overheating temperature T_{overheating} when the conditions correspond to the stall point, that is to say when the temperature gradient corresponds to the temperature gradient of the stall point, as is illustrated by the curve Cₘₐₓ in FIG. 4, in which curves of variation of the temperature T of the oil as a function of time t are illustrated.

In a following step 340, the second temperature T₂ is compared with a deactivation threshold T_{deactivation}. If the second temperature T₂ is below this deactivation threshold T_{deactivation} the control system 20 is deactivated.

In a variant, the first temperature T₁ can be used for the comparison of the step 340 in place of the second temperature T₂.

The overheating temperature T_{overheating} of the oil corresponds to the temperature of the oil from which there is a risk of degradation of the elements of the hydraulic torque converter 13 if such a temperature or a higher temperature is maintained even over a relatively short period of time.

The temperature gradient Grad(T) is determined based on the first temperature T₁, the second temperature T₂ and the critical period t_{critical}. The stall point of the torque converter 13 is reached when, at a given practical mass, the force of resistance to forward travel of the motor vehicle is equal to the force produced by the maximum engine torque built up by the engine 11 and available in the case of maximum shearing of the converter, and geared down by the hydraulic converter and the automatic transmission as far as the wheels. The maximum thermal iso-stress curve Isoₘₐₓ illustrated in FIG. 4 corresponds to the stall point.

In a following step 350, the determination means 21 determine the temperature gradient Grad(T) between the first and second temperatures T₁ and T₂ for the critical period t_{critical}.

The temperature gradient Grad(T) thus determined makes it possible to deduce the force of resistance to forward travel to which the vehicle is subjected in relation to the practical mass of said vehicle, without using data provided by additional sensors, that is to say to estimate the incline and/or the nature of the terrain on which the vehicle is located. This estimation thus makes it possible to know the environmental conditions of the motor vehicle and to anticipate the potential or available operating conditions for the motor vehicle.

In a following step 360, the estimation means 22 thus estimate a curve of the force of resistance to forward travel of the motor vehicle depending on a practical mass of the motor vehicle based on the temperature gradient Grad(T) determined in the previous step 350.

In a step 370, the curve estimated in the previous step 360 is then compared with a threshold curve, corresponding to a static thermal iso-stress curve Iso_{static} illustrated in FIG. 4.

The static thermal iso-stress curve Iso_{static} corresponds to the maximum force of resistance to forward travel depending on the practical mass for which the temperature of the oil remains below the overheating temperature T_{overheating}, whatever the value of the engine torque and the period of time over which this has built up. The iso-stress curves are dependent on the characteristics of the heat exchangers associated with the hydraulic torque converter 13 and on the desired takeoff abilities.

An example of a temperature curve of the oil for traveling conditions approaching or corresponding to the static thermal iso-stress curve Iso_{static} is illustrated by the curve C_{static} in FIG. 4.

When the estimated curve of the force of resistance to forward travel depending on a practical mass is below the static thermal iso-stress curve Iso_{static}, zone I in FIG. 3, the hydraulic torque converter 13 is experiencing operating conditions in which the temperature of the oil is not at risk of exceeding the overheating temperature T_{overheating,} as illustrated by the curves C_{static} and C_{d} in FIG. 4. The engine torque therefore does not need to be limited in order to reduce the temperature of the oil, and the process starts again at the first step 310.

When the estimated curve of the force of resistance to forward travel depending on a practical mass is between the static thermal iso-stress curve Iso_{static} and the maximum thermal iso-stress curve Isoₘₐₓ, zone II in FIG. 3, the means 23 for controlling the engine torque limit the engine torque in a final step 370. The traveling conditions of the motor vehicle corresponding to zone II correspond to temperature variations illustrated by the curves Cₐ, C_{b} and C_{c} in FIG. 4.

The zone, zone III in FIG. 3, corresponding to an estimated curve of the force of resistance to forward travel depending on a practical mass greater than the maximum thermal iso-stress curve Isoₘₐₓ is asymptotic. It therefore can never be reached in the sense that the maximum thermal iso-stress curve Isoₘₐₓ, corresponding to the stall point for given characteristics of the engine, of the hydraulic converter, of the transmission and of the vehicle mass, and for maximum ambient temperature conditions of the vehicle or of the engine compartment, can be considered as a practical absolute limit.

In the final step 380, the means 23 for controlling the engine torque determine a rate of reduction of the engine torque or a limited value of engine torque to be applied to the engine 11 in order to reduce the oil temperature in the hydraulic torque converter 13.

The determination of the temperature gradient thus makes it possible to deduce, via an estimation of the force of resistance to forward travel depending on a practical mass, the period of time over which the motor vehicle can function with a significant engine speed and torque before reaching the overheating temperature T_{overheating} of the oil, and thus makes it possible to anticipate the behavior of the motor vehicle. The determination of the temperature gradient Grad(T) thus makes it possible to know the period of time over which the maximum engine torque making it possible to obtain a maximum clearing force is available for a given curve of the force of resistance to forward travel depending on the practical mass.

In FIG. 4, the curve Cₑ illustrates traveling conditions considered normal, that is to say for which the activation threshold T_{activation} will not be exceeded and the control system 20 therefore will not be activated.

The invention thus makes it possible to implement at any moment the best possible compromise between the thermal resistance of the automatic transmission and the maximum clearing force exerted against the force of resistance to forward travel depending on the practical mass of the vehicle, moreover without using additional sensors or means making it possible to obtain information concerning the load conditions of the motor vehicle imposed by the terrain.

In addition, the invention allows the motor vehicle to benefit from a reserve of clearing force making it possible to clear obstacles, such as humps or holes, when the vehicle is already located in a zone putting up a high resistance to forward travel, such as a steep incline or a sandy terrain, moreover without risking degradation of the structural elements of the hydraulic torque converter of the transmission.

The continuous management in real time of the adaptation of the engine torque to the surrounding circumstances, that is to say to the force of resistance to forward travel of the vehicle, makes it possible to anticipate the behavior of the motor vehicle and consequently to give the driver maximum confidence in the behavior of his motor vehicle, which remains constant and foreseeable. By controlling the engine torque transmitted to the hydraulic torque converter with respect to the estimated curve of the force of resistance to forward travel depending on the practical mass, it is possible to anticipate critical situations and to avoid an interruption of torque to the wheels associated with such a situation. The circumstantial corrections of the torque applied to the wheels are never sudden and do not place the driver and his vehicle, without warning, in dangerous situations which could clearly place them and also passengers or third parties instantly in danger.

In addition, the invention makes it possible, for lower vehicle practical masses or lower ambient temperatures, to increase the clearing ability compared with that for which, with maximum mass of the vehicle, the dimensioning of the heat exchangers has been defined. In addition, the clearing ability is not altered unilaterally and is not limited to a level below that allowed a priori by the other parameters and characteristics of the vehicle.

The invention is also robust with respect to the differences of practical mass of motor vehicles, ascended inclines and terrain conditions. The process of calibration of the invention is simple since a characterization performed for just a few minutes is sufficient for the device to be operational and adapted to the vehicle in question.

The invention does not rule out the use of a potential sensor for sensing an instantaneous gradient, of information provided by a satellite guiding or positioning device, or of information able to give the actual mass of the vehicle.

1-11. (canceled)

12. A system for controlling a power train of a motor vehicle, the power train configured to deliver an engine torque to a hydraulic torque converter, the control system comprising:
means for determining a temperature gradient of oil of the hydraulic torque converter;
means for estimating a curve of force of resistance to forward travel of the motor vehicle depending on a practical mass of the motor vehicle based on the temperature gradient; and
means for controlling the engine torque depending on the estimation.

13. The system as claimed in claim 12, further comprising a temperature sensor configured to measure the temperature of the oil in the hydraulic torque converter and coupled to the means for determining, the means for determining a temperature gradient based on a difference between two oil temperature measurements separated by a critical period.

14. The system as claimed in claim 12, wherein the means for controlling comprises a module for limiting the engine torque and configured to determine a limited engine torque when the estimated curve of the force of resistance to forward travel depending on a practical mass is between a static thermal iso-stress curve and a maximum thermal iso-stress curve, the static thermal iso-stress curve corresponding to a maximum force of resistance to forward travel depending on the practical mass for which the temperature of the oil remains below an overheating temperature, whatever a value of the engine torque and the period of time over which the engine torque has built up, and the maximum thermal iso-stress curve corresponding to a force of resistance to forward travel of a stall point of the hydraulic torque converter.

15. The system as claimed in claim 13, further comprising an activation module coupled to the temperature sensor and configured to activate the control system when the temperature of the oil is greater than an activation temperature, the activation temperature corresponding to a maximum temperature observed for normal traveling conditions of the vehicle.

16. The system as claimed in claim 15, wherein the activation module is configured to deactivate the control system when the temperature of the oil is below a deactivation temperature, the deactivation temperature corresponding to a temperature indicative of a return to normal traveling conditions of the vehicle.

17. The system as claimed in claim 15, wherein the critical period corresponds to a time taken for the oil to pass from the activation temperature to the overheating temperature when the temperature gradient corresponds to a temperature gradient of a stall point.

18. A method for controlling a power train of a motor vehicle, the power train being configured to deliver an engine torque to a hydraulic torque converter, the method comprising:
determination of a temperature gradient of an oil of the hydraulic torque converter;
estimation of a curve of the force of resistance to forward travel of the motor vehicle depending on a practical mass of the motor vehicle based on the temperature gradient; and
a control of the engine torque depending on the estimation.

19. The method as claimed in claim 18, wherein the temperature gradient is determined based on a difference between two measurements of the temperature of the oil separated by a critical period.

20. The method as claimed in claim 18, wherein the control of the engine torque limits the engine torque when an estimated curve of the force of resistance to forward travel depending on a practical mass is between a static thermal iso-stress curve and a maximum thermal iso-stress curve, the static thermal iso-stress curve corresponding to a maximum force of resistance to forward travel depending on the practical mass for which the temperature of the oil remains below an overheating temperature, whatever a value of the engine torque and a period of time over which the engine torque has built up, and the maximum thermal iso-stress curve corresponding to a force of resistance to forward travel depending on the practical mass of a stall point of the hydraulic torque converter.

21. The method as claimed in claim 18, wherein the control of the engine torque is activated when the temperature of the oil is greater than an activation temperature, the activation temperature corresponding to a maximum temperature observed for normal traveling conditions of the vehicle.

22. The method as claimed in claim 21, wherein the critical period corresponds to a time taken for the oil to pass from the activation temperature to an overheating temperature when the temperature gradient corresponds to a temperature gradient of a stall point.
